(19) United States
(12) Patent Application Publication
(10) Pub. No.: US 2013/0042176 A1
(43) Pub. Date: Feb. 14, 2013

(54) METHODS SYSTEMS AND COMPUTER PROGRAM PRODUCTS FOR MANAGING SOUND FILES OF A VEHICLE

(71) Applicants: David A. Polehna, Fenton, MI (US); Thomas K. Dye, Novi, MI (US)

(72) Inventors: David A. Polehna, Fenton, MI (US); Thomas K. Dye, Novi, MI (US)

(73) Assignee: GM GLOBAL TECHNOLOGY OPERATIONS LLC, DETROIT, MI (US)

(21) Appl. No.: 13/208,457

(22) Filed: Aug. 12, 2011

(51) Int. Cl. G06F 3/01

(52) U.S. Cl. 715/716

(57) ABSTRACT

A system for managing sound files of a vehicle is provided. The system includes one or more computer readable media. The one or more computer readable media includes an information manager that stores purchase information to a datastore; and an audio file manager that receives selection information and that transmits an audio file to the vehicle based on the selection and the purchase information.

### FIELD OF THE INVENTION

The subject invention relates to methods, systems, and computer program products for securely managing sound files of a vehicle.

### BACKGROUND

Electric and hybrid vehicles are typically quieter than vehicles with an internal combustion engine. In some cases, when the engine is not running, it is difficult to discern whether the vehicle is in operation. Sounds systems of the vehicle can be configured to play an audio file during operation of the vehicle to notify a passerby that the vehicle is in operation.

Accordingly, it is desirable to provide a methods and systems for selectively configuring the audio files.

### SUMMARY OF THE INVENTION

In one exemplary embodiment of the invention, a system for managing sound files of a vehicle is provided. The system includes one or more computer readable media. The one or more computer readable media includes an audio file datastore that stores authorized audio files. An audio file manager receives selection information and transmits at least one of the authorized audio files to the vehicle based on the selection.

In another exemplary embodiment of the invention, a method of managing audio files of a vehicle is provided. The method includes: performing on one or more processors, storing audio files to a datastore; receiving selection information; and transmitting an audio file of the authorized audio files to the vehicle based on the selection information.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a functional block diagram of a sound management system that includes one or more remote devices that communicate with a vehicle in accordance with exemplary embodiments;

FIG. 2 is a dataflow diagram illustrating sound management applications of the sound management system in accordance with exemplary embodiments; and

FIG. 3 is a flowchart illustrating a sound management method that can be performed by the sound management system in accordance with exemplary embodiments.

### DESCRIPTION OF THE EMBODIMENTS

The following description is merely exemplary in nature and is not intended to limit the disclosure, its application or uses. It should be understood that throughout the drawings, corresponding reference numerals indicate like or corresponding parts and features. As used herein, the term module refers to an application specific integrated circuit (ASIC), an electronic circuit, a processor (shared, dedicated, or group) and memory that executes one or more software or firmware programs, one or more software or firmware programs, a combinational logic circuit, and/or other suitable components that provide the described functionality.

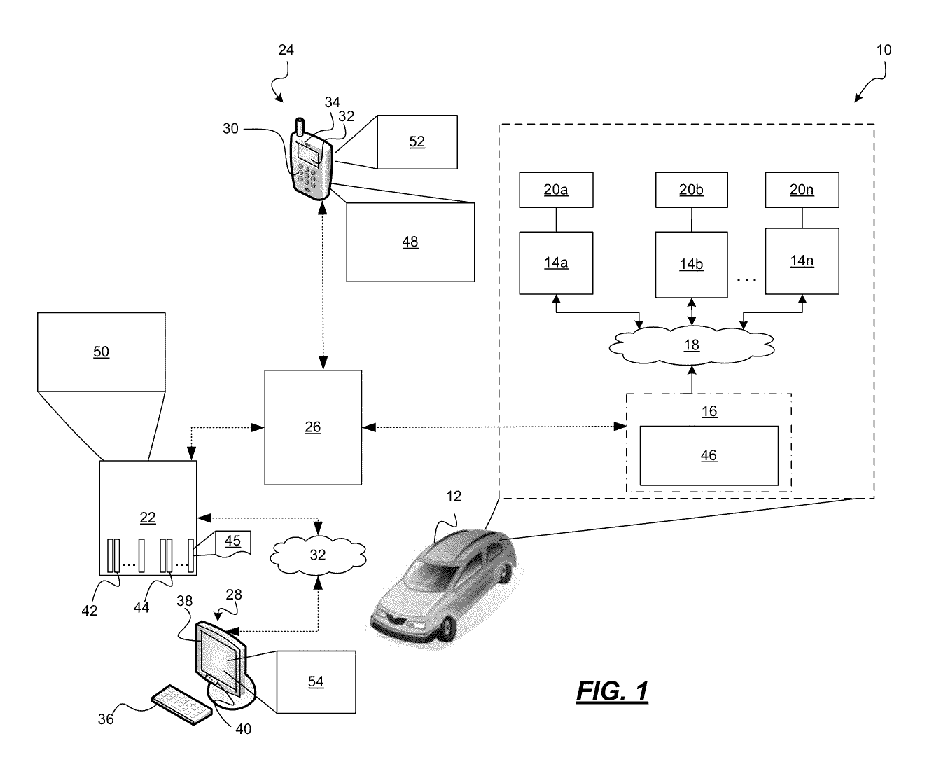

In accordance with various embodiments of the present disclosure, a sound management system for a vehicle 12 is shown generally at 10 of FIG. 1. Generally speaking, the sound management system 10 provides secure methods and systems for managing authorized or regulatory compliant audio files of the vehicle 12. The sound management system 10 can include the ability to allow the audio files to be purchased and downloaded to the vehicle 12 using a secure method that would not allow anyone or other system to manipulate or alter the audio files in any way.

With particular reference now to FIG. 1, the vehicle 12 includes one or more control modules 14a-14n that communicate with each other and a telematic system 16 via a vehicle network 18. The control modules 14a-14n control one or more vehicle systems 20a-20n and can include, for example, but are not limited to, an engine control module, a transmission control module, a body control module, and other electronic modules or devices resident within the vehicle 12.

As can be appreciated, the vehicle network 18 can include any combination of wired or wireless communication channels. For example, the vehicle network 18 can include a single communication bus or a combination of various communication buses that are implemented according to vehicle communication network standards, such as, for example, Controller Area Network (CAN), Society of Automotive Engineers (SAE) J1850, and General Motors Local Areal Network (GMLAN), etc.

The telematic system 16 can communicate with a central server 22 and/or a personal handheld device 24 via one or more wireless communication mediums 26 (e.g., a satellite, a tower, etc.) using an applicable network protocol (e.g., a telecommunications protocol, such as, GSM, CDMA, 3G, HSPA+, 4G, LTE, etc., any wireless protocol, such as, Wi-Fi, BlueTooth, etc.). A computing device 28 communicates with the central server 22 via one or more wired or wireless communication mediums using an applicable network protocol.

As can be appreciated, the personal handheld device 24, the central server 22, and the computing device 28 can be any electronic device that includes a processor and memory. In the example of FIG. 1, the personal handheld device 24 is a phone that is configured to include, one or more input devices 30, a display 32, and an audio output 34. The computing device 28 is a laptop computer that includes one or more input devices 36, a display 38, and an audio output 40. The central server 22 is a server that includes multiple processors 42 and storage mediums 44.

The sound management system 10 includes one or more sound management applications. Generally speaking, the sound management applications include software instructions that, when executed by the processor of the electronic device, facilitate the purchase of audio files 45 and the transmittal of the audio files 45 to the vehicle 12. In various embodiments, the audio files 45 can be sound files that have been approved by a regulatory entity (e.g., the government, the automobile manufacturer, etc.) and stored to the central server 22. The audio files 45 can be configured (e.g., configured by a user, configured by the regulatory entity or administrator, etc.) to be played based on one or more vehicle operations. For example, a particular audio file 45 can be configured to be played by the pedestrian alert function of the vehicle 12 to notify a passerby that the vehicle 12 is in operation.

In various embodiments, the sound management applications can include a vehicle application 46 that resides on the vehicle 12, for example, as a part of the telematic system 16, a device application 48 that resides on the personal handheld device 24, and a server application 50 that resides on the central server 22. As can be appreciated, the sound management applications can be implemented as multiple applications, partly on any combination of the central server 22, the personal handheld device 24, and the vehicle 12 and is not limited to the present example. Alternatively, the sound management applications can be implemented as a single application and can reside on any one of the vehicle 12, the central server 22, and the personal handheld device 24. In various embodiments, the sound management applications manage the audio files through one or more user interfaces 52, 54 that can be displayed by the display 32, 38 of the personal handheld device 24 and/or the computing device 28, respectively.

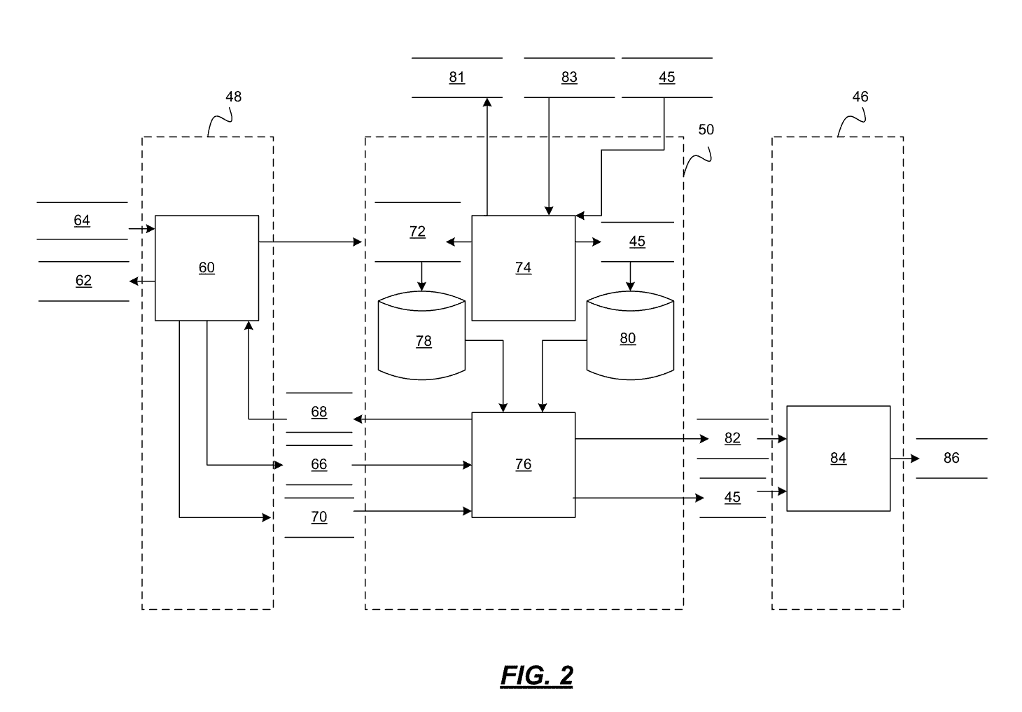

Referring now to FIG. 2, a dataflow diagram illustrates various embodiments of the sound management applications and the communications therebetween. As can be appreciated, FIG. 2 is merely an example, and the various sub-components of the sound management applications may be combined and/or further partitioned to similarly manage the purchase and/or configuration of the audio files 45 for the vehicle 12.

In the exemplary embodiments of FIG. 2, the device application 48 includes an interface manager 60. The interface manager 60 manages the user interface 52 (FIG. 1) and the selection and purchase of an audio file 45 by communicating with the server application 50. The interface manager 60 manages the display of the user interface 52 (FIG. 1) by generating display data 62, and manages the receipt of information entered by a user when interacting with the user interface (FIG. 1) (e.g., by interacting with one or more of the input devices 30 (FIG. 1)) by receiving user input data 64. Based on the user input data 64, the interface manager 60 generates a file request 66 to the server application 50 and receives file information 68 (e.g., a file list, associated vehicle operation, audio clips, etc.) from the server application 50. Further based on the user input data 64 the interface manager 60 generates selection information 70 indicating the selected audio file 45 for purchase. For example, to select an audio file 45, the interface manager 60 generates the file request 66, receives the file information 68, displays a file list based on the file information 68, optionally plays a portion or all of a selected audio file 45, receives user input data indicating a selected file, and generates the selection information 70 to indicate the selected file.

In various embodiments, the interface manager 60 can manage the configuration of purchase information (i.e., payment information, personal information, etc.) and/or security information (e.g., password setup, login information) 72 through the user interface 52 (FIG. 1). For example, the interface manager 60 can generate display data 62 to display text input boxes and/or selection boxes in the user interface 52 (FIG. 1). The interface manager 60 can receive user input data 64 indicating the purchase information and/or security information entered by a user. The interface manager 60 then transmits the purchase information and/or security information 72 to the server application 50 for storage.

In the exemplary embodiments of FIG. 2, the server application 50 includes an information manager 74, an audio file manager 76, a personal information datastore 78, and an audio file datastore 80.

The information manager 74 manages the uploading of the audio files 45 to the audio file datastore 80 through the user interface 54 (FIG. 1). The interface manager 60 manages the display of the user interface 54 (FIG. 1) by the display 38 (FIG. 1) by generating display data 81, and manages the receipt of information entered by a user when interacting with the user interface 54 (FIG. 1) (e.g., by interacting with one or more of the I/O devices 56 (FIG. 1)) by receiving user input data 83. For example, to upload an audio file 45, the information manager 74 can receive user input data 83 indicating an upload request and security and/or login information, can verify the security and/or login information, and can receive the audio file 45 and store the audio file 45 to the audio file datastore 80.

In various embodiments, the information manager 74 can manage the configuration of purchase information (i.e., payment information, personal information, etc.) and/or security information (e.g., password setup, login information) through the user interface 54 (FIG. 1) in a similar manner as described with regard to the interface manager 60 of the device application 48. In various embodiments, the information manager 74 can manage the purchase of an audio file 45 in a similar manner as described with regard to the interface manager 60 of the device application 48.

The audio file manager 76 receives as input the security information, and the file request that is generated from either 68 of the device application 48 or the information manager 74. Based on the security information, the audio file manager 76 authenticates the communication from the device application 48 or the information manager 74. Once the communication has been authenticated, the audio file manager 76 generates the file information 68 including a list of available audio files 45 for purchase based on the file request 68.

The audio file manager 76 may further receive as input the selection information 70. Based on the selection information 70, the audio file manager 76 retrieves the purchase information 72 from the datastore 78 and performs the purchase transaction. Once the transaction is complete, the audio file manager 76 establishes a communication with the vehicle 12 (FIG. 1). In various embodiments, the communication can be a secured communication using security information 82. The audio file manager 76 transmits the audio file 45 to the vehicle application 46.

In the exemplary embodiments of FIG. 2, the vehicle application 46 includes a vehicle sound manager 84. The vehicle sound manager 84 receives as input the security information 82 and the audio file 45. In various embodiments, the vehicle sound manager 84 authenticates the communication from the server application 50 using the security information 82. If the communication is authenticated, the vehicle sound manager 84 receives the audio file 45. The vehicle sound manager 84 then makes the audio file 45 available for use for example, by generating a message 86 on the vehicle network 18 that includes the audio file 45 or by storing the audio file 45 to a storage medium that can be accessed for use by one or more of the control modules 14a-14n. In various embodiments, the message 86 may include information indicating for what operation the audio file 45 is to be used or the audio file 45 may be stored in a manner that indicates for what operation the audio file 45 is to be used (e.g., stored to a particular location, or stored with an identifier, etc.).

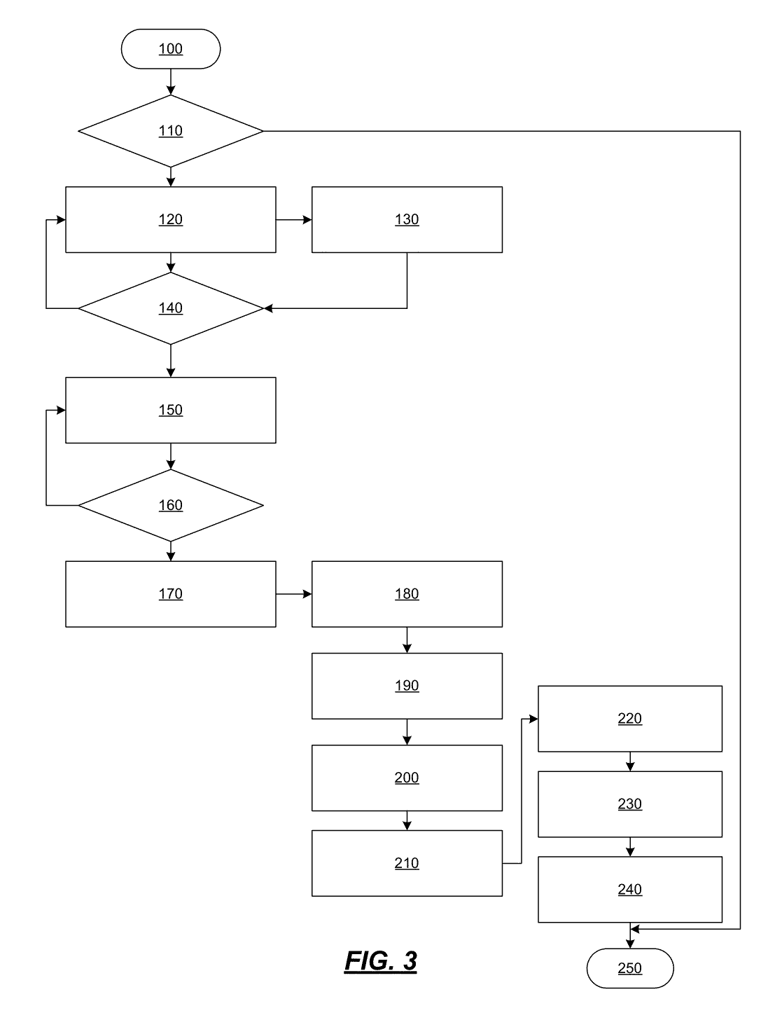

With reference now to FIG. 3 and with continued reference to FIG. 2, a flowchart illustrates a sound management method that can be performed by a sound management system in accordance with exemplary embodiments. As can be appreciated in light of the disclosure, the order of operation within the method is not limited to the sequential execution as illustrated in FIG. 3, but may be performed in one or more varying orders as applicable and in accordance with the present disclosure.

In one example, the method may begin at 100. It is determined whether a user has initiated the device application 48 or the server application 50 to purchase an audio file 45 at 110. Once a user initiates the application 48, 50, the user interface 52, 54 is displayed and the file request 66 for file information is generated at 120. The file data is retrieved from the audio file datastore 80 and generated at 130. Once the file information 68 has been received at 140, the file information 68 is displayed in the user interface 52, 54 at 150. Once user input 64, 84 is received by the user interacting with the user interface 52, 54 via the input devices 30, 36 (FIG. 1) at 160, the selection information 70 is generated at 170.

The selection information 70 is then received at 180. The purchase transaction is processed based on the purchase information 72 stored in the datastore 78 (e.g., in this example the purchase information 72 is preconfigured and stored in the datastore 78) at 190. A secure connection is established at 200, and the audio file 45 is transmitted to the vehicle 12 (FIG. 1) at 210.

The communication including the audio file 45 is verified at 220, and the audio file 45 is received at 230. The audio file 45 is then made available for use by vehicle functions at 240. Thereafter, the method may end at 250.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed but that the invention will include all embodiments falling within the scope of the application.

What is claimed is:

1. A system for managing sound files of a vehicle, comprising:
one or more computer readable media, comprising:
an audio file datastore that stores authorized audio files; and
an audio file manager that receives selection information and that transmits at least one of the authorized audio files to the vehicle based on the selection.

2. The system of claim 1, further comprising an interface manager that generates the selection information based on user input.

3. The system of claim 2, wherein the interface manager resides on a computer readable medium of a portable handheld device.

4. The system of claim 3, further comprising an information manager that stores purchase information to a datastore, wherein the interface manager transmits the purchase information to the information manager based on user input.

5. The system of claim 1, wherein the audio file manager transmits the authorized audio file using a secure protocol.

6. The system of claim 1, further comprising a vehicle sound manager that receives the audio file and that associates the audio file with a function of the vehicle.

7. The system of claim 5, wherein the vehicle sound manager resides on a computer readable medium of the vehicle.

8. The system of claim 6, wherein the computer readable medium is of a telematic system of the vehicle.

9. The system of claim 1, further comprising an information manager that securely manages the authorized audio files within the datastore.

10. The system of claim 1, wherein the audio file manager manages a purchase transaction associated with the audio file based on purchase information.

11. A method of managing audio files of a vehicle, comprising:
performing on one or more processors,
storing audio files to a datastore;
receiving selection information; and
transmitting an audio file of the authorized audio files to the vehicle based on the selection information.

12. The method of claim 11, further comprising generating the selection information based on user input.

13. The method of claim 11, further comprising displaying a user interface associated with the audio files on a portable handheld device, and wherein the selection information is received based on a user interacting with the user interface.

14. The method of claim 11, further comprising displaying a user interface associated with the audio files on a computing device, and wherein the selection information is received based on a user interacting with the user interface.

15. The method of claim 11, further comprising:

16. receiving the audio file at the vehicle; and

17. associating the authorized audio file with a function of the vehicle.

18. The method of claim 11, further comprising managing a purchase transaction associated with the audio file based on purchase information.

19. The method of claim 11, wherein the transmitting is performed according to a secure protocol.

20. The method of claim 11, further comprising securely managing the storing of the audio files to the datastore.
